(19) United States
(12) Patent Application Publication
(10) Pub. No.: US 2008/0019812 A1
(43) Pub. Date: Jan. 24, 2008

(54) Cab-over loading frame

(76) Inventor: Dennis Moryski, Lethbridge (CA)

Correspondence Address: SUZANNAH K. SUNDBY;SMITH, GAMBRELL & RUSSEL, LLP, 1130 Connecticut Avenue, NW, Suite 1130, WASHINGTON, DC, 20036, US

(21) Appl. No.: 11/488,684

(22) Filed: Jul. 19, 2006

(51) Int. Cl. B60P 9/00

(52) U.S. Cl. 414/462

(57) ABSTRACT

A cab-over loading frame for use with a transport vehicle in loading, transporting and unloading auxiliary vehicles such as all-terrain vehicles and personal watercraft.

### FIELD OF THE INVENTION

The present invention relates to vehicle transport means, and more particularly to loading means for auxiliary vehicles being transported.

### BACKGROUND OF THE INVENTION

The use of auxiliary vehicles, such as all-terrain vehicles and personal watercraft, has become widespread for recreational purposes. It has accordingly been necessary to develop various means for transporting such auxiliary vehicles to the recreation site of interest.

It is common to tow a flat-bed trailer behind the primary vehicle (the transport vehicle), which can be used to carry the auxiliary vehicle. However, users of such auxiliary vehicles are also commonly engaged in the use of hitch-pulled RV (recreational vehicle) units for accommodation at the recreation site, and the hitch assembly (whether of the fifth wheel variety or otherwise) is then often employed to pull the RV and cannot be used for auxiliary vehicle transport.

What is needed, therefore, is an apparatus to enable the concurrent transport, using a single transport vehicle, of both an accommodation unit (such as an RV) and an auxiliary recreation vehicle.

### SUMMARY OF THE INVENTION

The present invention accordingly seeks to provide a frame for attachment to a transport vehicle which can enable transport of an auxiliary vehicle while not interfering with the ability to concurrently tow an accommodation unit.

According to a first aspect of the present invention, then, there is provided a frame for mounting on a transport vehicle having a user cab, for enabling loading, transportation and unloading of an auxiliary vehicle on the transport vehicle, the frame comprising:
a transport sub-frame comprising:
   a retention platform for receiving the auxiliary vehicle; and
   platform support means connected to the transport vehicle and the retention platform, for supporting the retention platform at a position above the user cab of the transport vehicle; and
a loading-unloading sub-frame comprising:
   track means for enabling the auxiliary vehicle to access the retention platform; and
   track support means connected to the transport vehicle and the track means, for supporting the track means on the transport vehicle.

According to a second aspect of the present invention there is provided a frame for mounting on a transport vehicle having a user cab, for enabling loading, transportation and unloading of an auxiliary vehicle on the transport vehicle, the frame comprising:
a transport sub-frame comprising:
   a retention platform for receiving the auxiliary vehicle; and
   platform support means connected to the transport vehicle and the retention platform, for supporting the retention platform at a position above the user cab of the transport vehicle; and
a loading-unloading sub-frame comprising:
   track means for enabling the auxiliary vehicle to access the retention platform; and
   track support means connected to the transport sub-frame and the track means, for supporting the track means on the transport vehicle.

According to a third aspect of the present invention there is provided a frame for mounting on a transport vehicle having a user cab, for enabling loading, transportation and unloading of an auxiliary vehicle on the transport vehicle, the frame comprising:
a transport sub-frame comprising:
   a retention platform for receiving the auxiliary vehicle; and
   platform support means connected to the transport vehicle and the retention platform, for supporting the retention platform at a position above the user cab of the transport vehicle; and
a loading-unloading sub-frame comprising track means for enabling the auxiliary vehicle to access the retention platform, the track means connected to the transport sub-frame.

In preferred embodiments of the present invention, the track support means are removably connected to the transport vehicle, wherein in a loading-unloading configuration the loading-unloading sub-frame is connected to the transport vehicle, and wherein in a transport configuration the loading-unloading sub-frame is disconnected from the transport vehicle. The loading-unloading sub-frame is most preferably collapsible to enable storage of the loading-unloading sub-frame in the transport vehicle when disconnected from the transport vehicle. The platform support means are also preferably removably connected to the transport vehicle, and the platform support means and the track support means are each preferably removably connected to the transport vehicle by means of quick-disconnect pin connections.

The transport vehicle is a truck comprising a bed portion in exemplary embodiments, and the track support means are then preferably connected to the transport vehicle by means of a connection member in the bed portion. The track support means may be connected to the transport vehicle by means of a fifth wheel assembly in the bed portion.

The track support means are preferably connected to the transport vehicle by means of a hitch assembly.

The frame according to the present invention preferably further comprises a winch assembly to enable loading and unloading of the auxiliary vehicle, which may be either a hand-operated winch or a motorized winch. Preferably, the loading-unloading sub-frame comprises a guide roller for guiding a cable of the winch assembly, the loading-unloading sub-frame comprises generally parallel tracks and guide rollers thereon for receiving and directing the auxiliary vehicle toward the retention platform, and the transport sub-frame comprises generally parallel tracks and guide rollers thereon for receiving and guiding the auxiliary vehicle into position on the retention platform.

The platform support means preferably comprise foot pegs for enabling a user to climb up to the auxiliary vehicle when positioned above the user cab of the transport vehicle. The auxiliary vehicle may comprise any one of a number of personal transport vehicles, including without limitation all-terrain vehicles and personal watercraft.

A detailed description of an exemplary embodiment of the present invention is given in the following. It is to be understood, however, that the invention is not to be construed as limited to this embodiment.

### BRIEF DESCRIPTION OF THE DRAWINGS

In the accompanying drawings, which illustrate an exemplary embodiment of the present invention:

FIG. 1 is a rear perspective view of a frame according to the present invention comprising a transport sub-frame and loading-unloading sub-frame;

FIG. 2 is a rear perspective view of the transport sub-frame;

FIG. 3 is a rear perspective view of the front support means of the transport sub-frame;

FIG. 4 is an exploded rear perspective view of a left front support means mount for the transport sub-frame;

FIG. 5 is an assembled rear perspective view of the left front support means mount of FIG. 4;

FIG. 6 is an exploded rear perspective view of a right front support means mount for the transport sub-frame;

FIG. 7 is an assembled rear perspective view of the right front support means mount of FIG. 6;

FIG. 8 is an exploded rear perspective view of a lower support brace for the transport sub-frame;

FIG. 9 is an assembled rear perspective view of the lower support brace of FIG. 8;

FIG. 10 is an exploded rear perspective view of vertical supports for the transport sub-frame;

FIG. 11 is an assembled rear perspective view of the vertical supports of FIG. 10;

FIG. 12 is an exploded rear perspective view of an upper support brace for the transport sub-frame;

FIG. 13 is an assembled rear perspective view of the upper support brace of FIG. 12;

FIG. 14 is a rear perspective view of the rear support means of the transport sub-frame;

FIG. 15 is an exploded rear perspective view of a lower bracket for the rear support means;

FIG. 16 is an assembled rear perspective view of the lower bracket of FIG. 15;

FIG. 17 is an exploded rear perspective view of an upper support for the rear support means;

FIG. 18 is an assembled rear perspective view of the upper support of FIG. 17;

FIG. 19a is a rear perspective view of a left guide rail for the transport sub-frame for use with watercraft;

FIG. 19b is a rear perspective view of a left guide rail for the transport sub-frame for use with wheeled auxiliary vehicles;

FIG. 19c is a detailed view of a bracket illustrated in FIG. 19b;

FIG. 20a is a rear perspective view of a right guide rail for the transport sub-frame for use with watercraft;

FIG. 20b is a rear perspective view of a right guide rail for the transport sub-frame for use with wheeled auxiliary vehicles;

FIG. 21 is an exploded rear perspective view of a winch mounting bracket for use with the transport sub-frame;

FIG. 22 is an assembled rear perspective view of the winch mounting bracket of FIG. 21;

FIG. 23 is a rear perspective view of the loading-unloading sub-frame;

FIG. 24 is an exploded rear perspective view of front support means for the loading-unloading sub-frame for mounting on a fifth wheel hitch assembly;

FIG. 25 is an assembled rear perspective view of the front support means of FIG. 24;

FIG. 26 is an exploded rear perspective view of rear support means for the loading-unloading sub-frame for mounting in a towing hitch means of the transport vehicle;

FIG. 27 is an assembled rear perspective view of the rear support means of FIG. 26;

FIG. 28a is a rear perspective view of a left guide rail for the loading-unloading sub-frame for use with watercraft;

FIG. 28b is a rear perspective view of a left guide rail for the loading-unloading sub-frame for use with wheeled auxiliary vehicles;

FIG. 29a is a rear perspective view of a right guide rail for the loading-unloading sub-frame for use with watercraft;

FIG. 29b is a rear perspective view of a right guide rail for the loading-unloading sub-frame for use with wheeled auxiliary vehicles; and

FIG. 30 is a side elevation view of a personal watercraft positioned above the transport vehicle cab by means of a frame according to the present invention.

### DETAILED DESCRIPTION OF EXEMPLARY EMBODIMENT

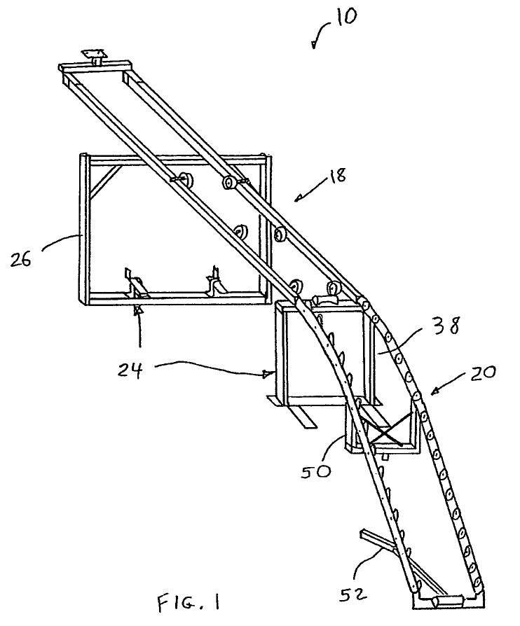

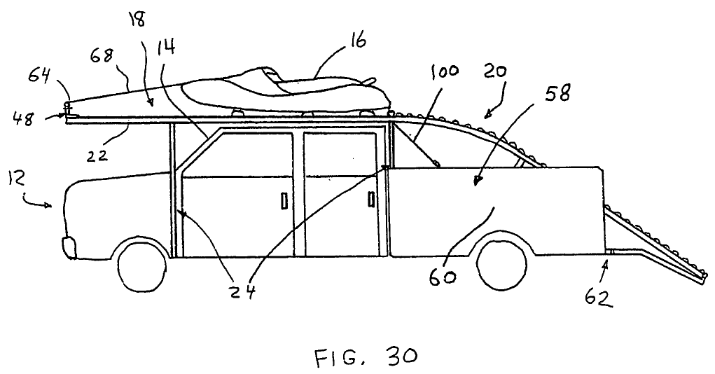

Referring now in detail to the accompanying drawings, there is illustrated an exemplary embodiment of a cab-over loading frame generally referred to by the numeral 10. Referring specifically to FIGS. 1 and 30, the frame 10 comprises a transport sub-frame 18 and a loading-unloading sub-frame 20. The frame 10 is removably connected to a transport vehicle 12, which in the illustrated embodiment is a pick-up truck with a cab 14 and a bed 58, the bed 58 being provided with a connection member 60 (which is illustrated as a fifth wheel hitch assembly) with a hitch assembly 62 at the rear of the transport vehicle 12.

The transport sub-frame 18 is illustrated in FIG. 30 as retaining an auxiliary vehicle 16 (in the illustrated instance a personal watercraft, although an all-terrain vehicle, snowmobile, or other auxiliary vehicle could be retained); the auxiliary vehicle could be strapped or chained in place once positioned correctly. The auxiliary vehicle 16 rests on a retention platform 22, which is supported by platform support means 24 removably connected to the transport vehicle 12. The platform support means 24 comprise front support means 26, removably connected to the transport vehicle 12 undercarriage behind the front wheels, and rear support means 38 mounted to the transport vehicle 12 frame from inside the bed 58. Quick-disconnect pin connections 74 are employed throughout, and are illustrated in numerous Figures.

The transport sub-frame 18 is provided with a winch mounting bracket 48 and winch assembly 64, which pulls the auxiliary vehicle 16 across the loading-unloading sub-frame 20 and onto the retention platform 22 of the transport sub-frame 18 by means of a cable 68. The winch assembly 64 is illustrated generally but can be either hand-operated or motorized, as would be obvious to one skilled in the art. As is described in detail below, the loading-unloading sub-frame 20 is removable and collapsible, and can be stored in the truck bed 58 when it is desired to employ the connection member 60 to pull an accommodation unit or to simply free up cargo space in the bed 58.

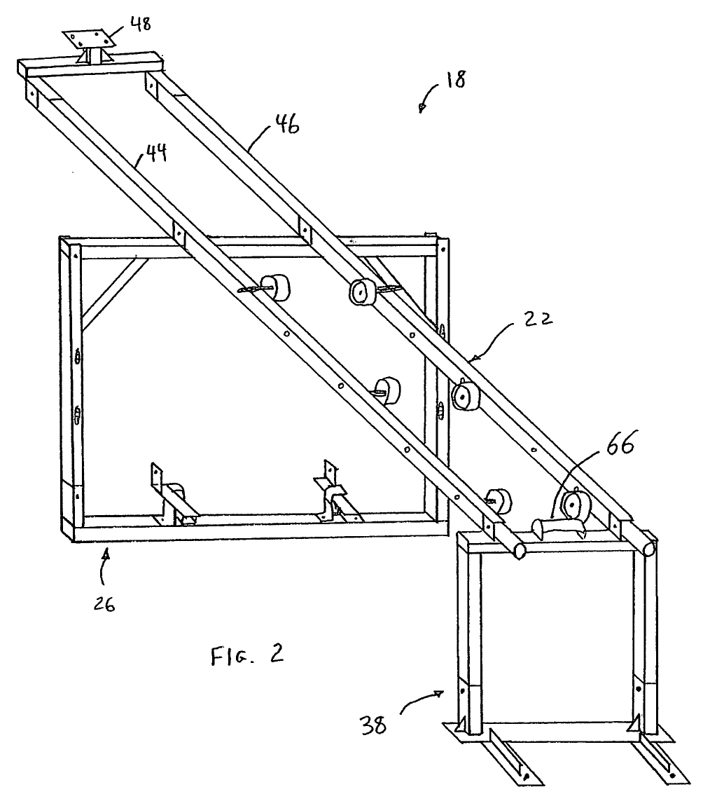

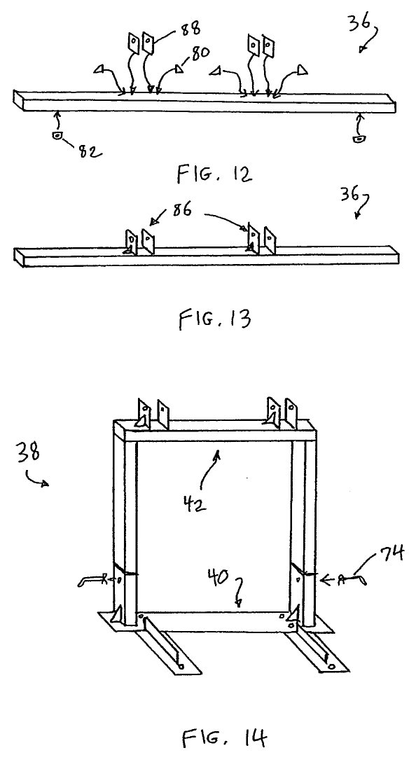

The transport sub-frame 18 is illustrated in detail in FIGS. 2 through 22. Referring to FIG. 2, the transport sub-frame 18 generally comprises front support means 26, rear support means 38, a winch mounting bracket 48, a cable guide roller 66, and a retention platform 22 which in the illustrated embodiment comprises left and right guide rails 44, 46 for receiving a personal watercraft as auxiliary vehicle 16. In addition, a support cable 100 is connected between the transport sub-frame 18 and the transport vehicle 12 that enhances stability of the frame 10, as seen in FIG. 30.

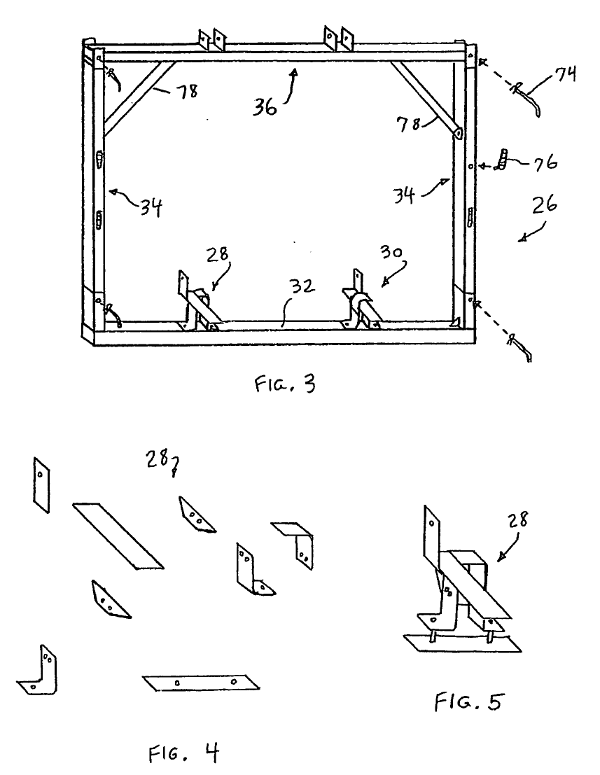

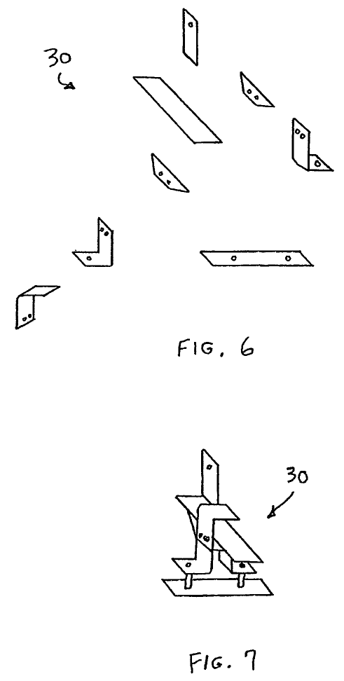

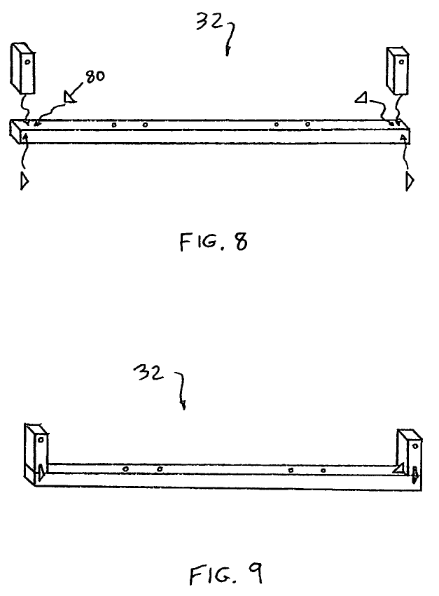

The front support means 26 of the transport sub-frame 18 are illustrated in FIG. 3, with component details in FIGS. 4 through 13. The front support means 26 comprise a left front support means mount 28, a right front support means mount 30, a lower support brace 32, vertical supports 34, and an upper support brace 36. The lower and upper support braces 32, 36 are pin-connected to the vertical supports 34, which vertical supports 34 are provided with flip-down foot pegs 76 to enable a user to climb upwardly to where the auxiliary vehicle 16 will be retained. The upper support brace 36 is further connected to the vertical supports 34 by braces 78, which are bolted in place.

Referring to FIGS. 4, 5, 6 and 7, the left and right front support means mounts 28, 30 each comprise a number of individual components made of ½ inch plate, with drilled holes to enable bolt attachment (as would be obvious to one skilled in the art, some of the connections between components would be by weld bonds). FIGS. 4 and 6 illustrate exploded views of the left and right front support means mounts 28, 30, while FIGS. 5 and 7 illustrate these elements when assembled. The left and right front support means mounts 28, 30 are for removably mounting the front support means 26 on the transport vehicle 12 undercarriage.

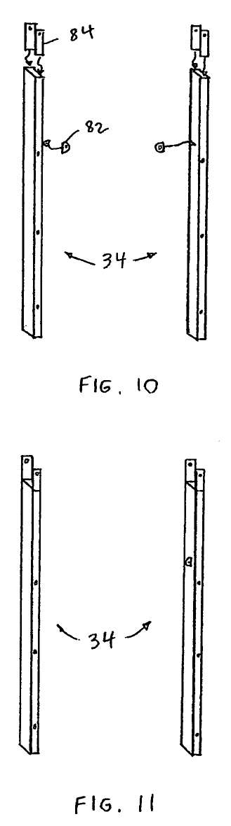

Referring to FIGS. 8 and 9, the lower support brace 32 is shown in exploded and assembled views. The component parts are made of square tubing, with four support gussets 80 mated to them using weld beads, the uprights sized to receive the vertical supports 34 therein. The vertical supports 34, illustrated in exploded and assembled views in FIGS. 10 and 11, are sized to fit within the uprights of the lower support brace 32, and comprise top plates 84 and support tabs 82 for respective connection to the upper support brace 36 and the braces 78. The upper support brace 36 itself is illustrated in FIGS. 12 (exploded) and 13 (assembled), and it comprises upper plates 88 (bead welded but reinforced by gussets 80) for forming brackets 86 for receiving the left and right guide rails 44, 46, and support tabs 82 for connection to the braces 78.

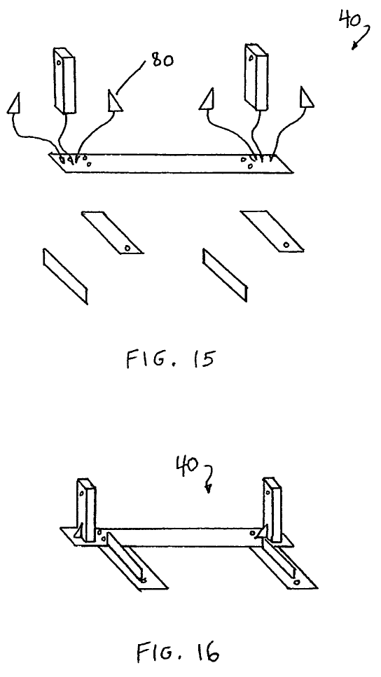

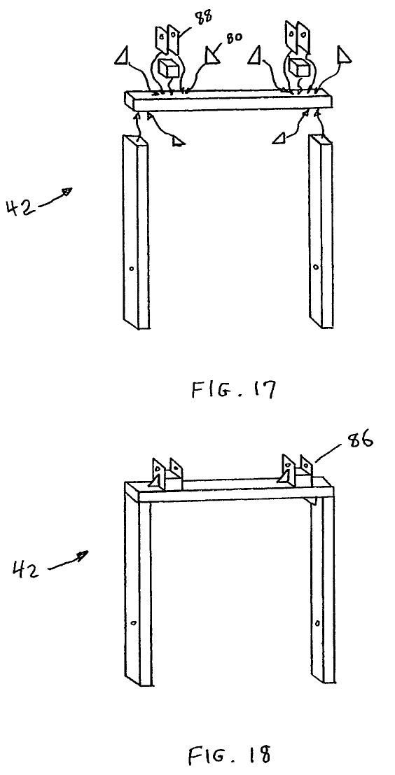

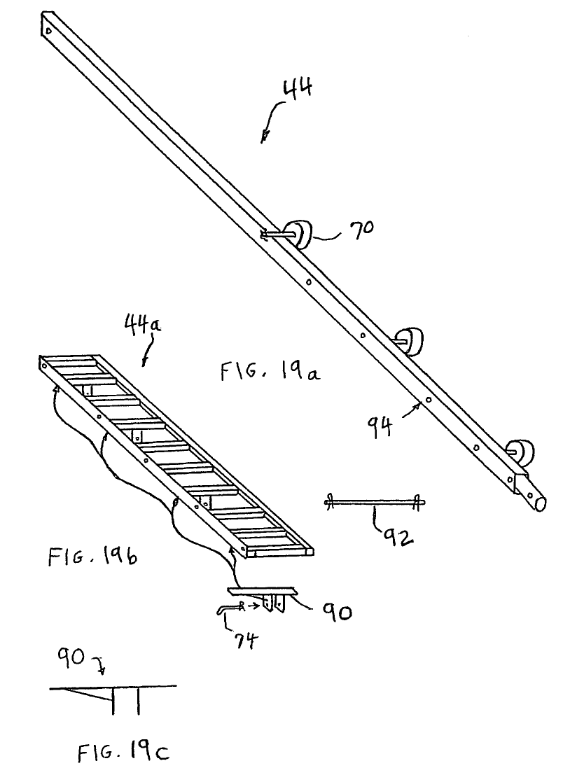

Turning to the rear support means 38, they are illustrated in FIGS. 14 through 18. The rear support means 38 comprise a lower bracket 40 and an upper support 42. The lower bracket 40 is illustrated in exploded and assembled views in FIGS. 15 and 16, respectively; the components are composed of square tubing and ½ inch plate, bead welded in position with support gussets 80. The upper support 42 is illustrated in exploded and assembled views in FIGS. 17 and 18, respectively; again, the components are composed of square tubing and ½ inch plate, bead welded in position with support gussets 80, and the upper support 42 also comprises upper plates 88 (as found on the front support means 26) forming brackets 86 for receiving the left and right guide rails 44, 46.

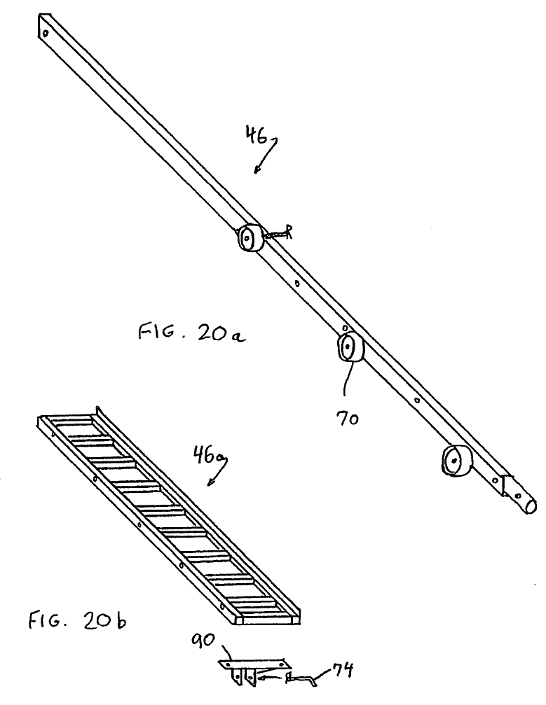

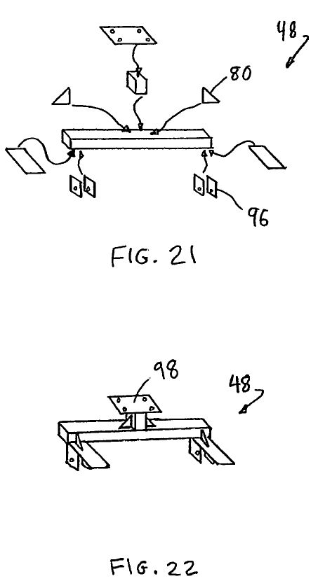

Turning now to FIGS. 19a to 19c, the left guide rail 44 for the transport sub-frame 18 is shown in detail. FIG. 19a illustrates an embodiment of the left guide rail 44 for use with personal watercraft, with guide rollers 70 for guiding the watercraft into position on the retention platform 22. In the event that a user wishes to transport an all-terrain vehicle instead of a personal watercraft, FIG. 19b illustrates an optional aluminium loading ramp 44a that can be mated with the guide rails 44, 46 by means of bolt holes 94, pins 74, and ramp support brackets 90 (the latter shown in side elevation detail in FIG. 19c). Optional support rods 92 can also be mounted between the cross-pieces of the ramp 44a where the user wishes to transport a snowmobile. The lower end of the left guide rail 44 is provided with a smaller diameter slip pipe for mating with the left guide rail 54 of the loading-unloading sub-frame 20, described below. The right guide rail 46 is illustrated in detail in FIG. 20a, a mirror image of the left guide rail 44, again with an optional ramp 46a illustrated in FIG. 20b.

FIGS. 21 and 22 illustrate, respectively, exploded and assembled views of the winch mounting bracket 48. The winch mounting bracket 48 comprises ½ inch plate, square tubing, support gussets 80, and lower plates 96 for attachment to the extreme forward ends of the left and right guide rails 44, 46. The upper face 98 is for receiving the winch assembly 64.

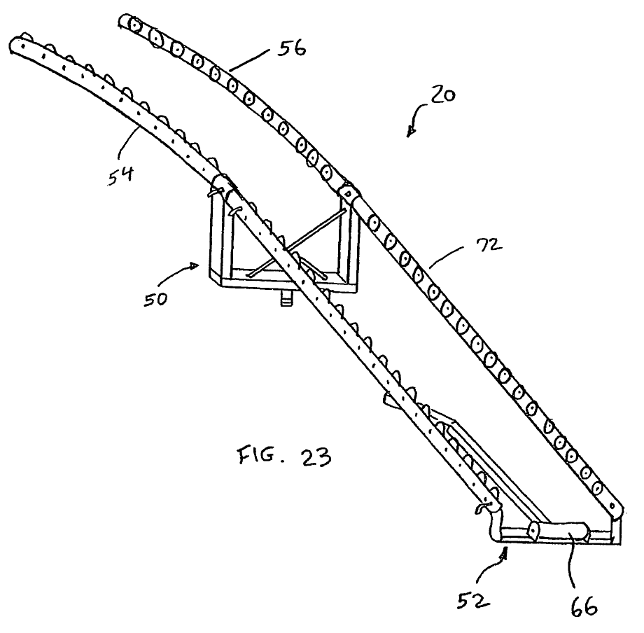

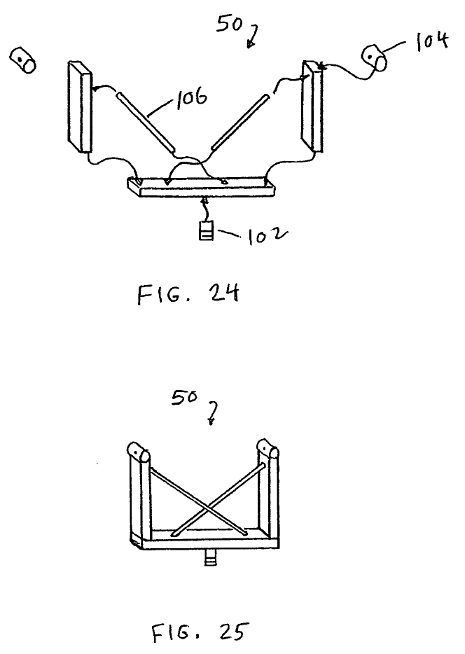

The loading-unloading sub-frame 20 is illustrated in FIGS. 23 to 29b. In the illustrated embodiment, the loading-unloading sub-frame 20 is removably connected to the transport vehicle 12 at two points, the connection member 60 and the hitch assembly 62, as can be seen in FIG. 30.

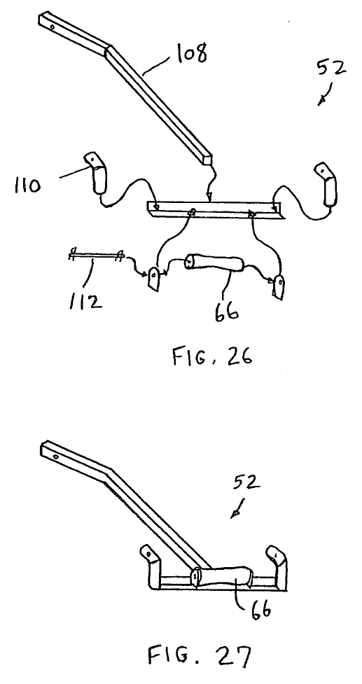

The loading-unloading sub-frame 20 comprises front support means 50, rear support means 52, a guide roller 66 (mounted on a rod 112 on the rear support means 52) for the cable 68, and left and right guide rails 54, 56 (these latter releasably mateable with the left and right guide rails 44, 46 of the transport sub-frame 18). The front support means 50 are illustrated in FIGS. 24 (exploded) and 25 (assembled), and comprise rectangular tubing with bracing rods 106, connecting pipe segments 104 for connecting forward and rear sections of the guide rails 54, 56, and a hitch pin for connection to the connection member 60, all joined by bead welding. The rear support means 52 are illustrated in detail in FIGS. 26 (exploded) and 27 (assembled) and comprise an angled square tubing section 108 for mating with the hitch assembly 62 of the transport vehicle 12, and angled connecting pipe segments 110 for mating with the rear ends of the guide rails 54, 56.

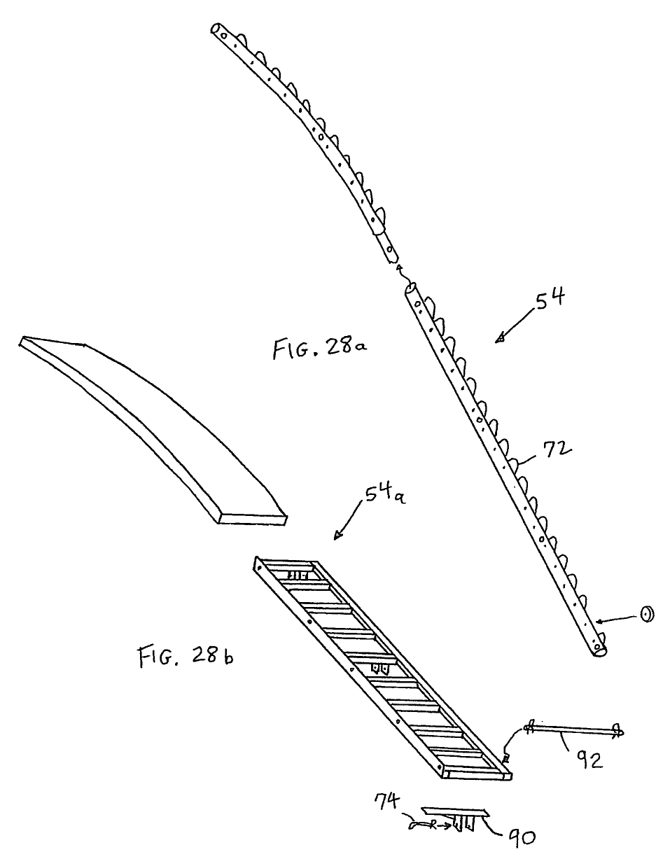

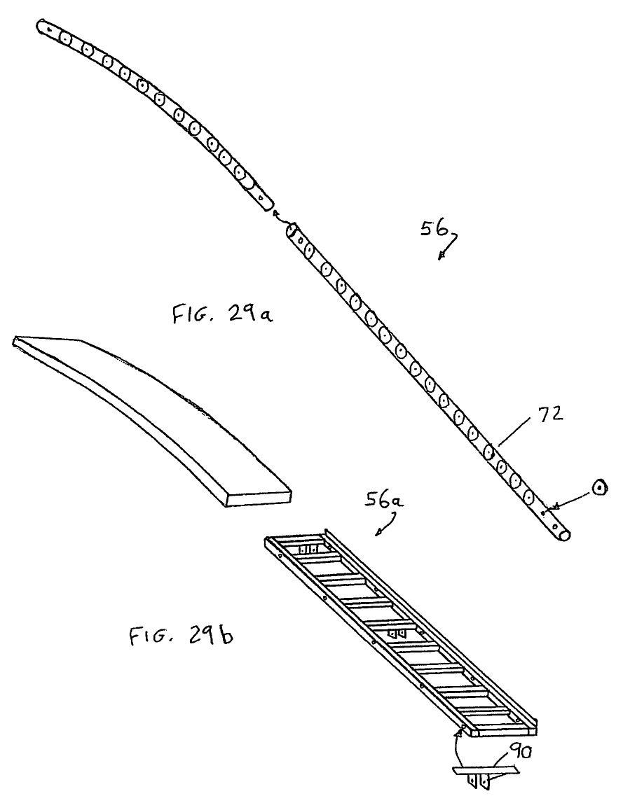

FIGS. 28a to 29b illustrate left and right guide rails 54, 56 for the loading-unloading sub-frame 20. As was the case with the left and right guide rails 44, 46 of the transport sub-frame 18, the left and right guide rails 54, 56 comprise guide rollers 72 for guiding personal watercraft forward toward the retention platform 22. The left and right guide rails 54, 56 can also be modified by optional ramps 54a, 56a (which comprise a steel forward ramp and rearward aluminium ramp), rail brackets 90, and support rods 92, as described above with respect to the left and right guide rails 44, 46. The forward half of the left and right guide rails 54, 56 may be bent slightly to provide for a gradual slope change for the auxiliary vehicle 16 as it is loaded onto the retention platform 22.

The loading-unloading sub-frame 20 can be disassembled in a matter of minutes, as can clearly be seen. With the use of quick-disconnect pins 74 and simple hitch mountings at the trailer hitch 62 and fifth wheel assembly 60 of the exemplary transport vehicle 12, the loading-unloading sub-frame 20 can be rapidly disconnected from the transport sub-frame 18 and transport vehicle 12, and can then be readily broken down into smaller components (again, due to the use of quick-disconnect pins 74) which can be stowed in the bed 58 of the transport vehicle 12 adjacent the fifth wheel assembly 60.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

Embodiments of the invention in which an exclusive property or privilege is claimed are defined as follows:

1. A frame for mounting on a transport vehicle having a user cab, for enabling loading, transportation and unloading of an auxiliary vehicle on the transport vehicle, the frame comprising:
a transport sub-frame comprising:
a retention platform for receiving the auxiliary vehicle; and
platform support means connected to the transport vehicle and the retention platform, for supporting the retention platform at a position above the user cab of the transport vehicle; and
a loading-unloading sub-frame comprising:
track means for enabling the auxiliary vehicle to access the retention platform; and
track support means connected to the transport vehicle and the track means, for supporting the track means on the transport vehicle.

2. The frame of claim 1 wherein the track support means are removably connected to the transport vehicle, wherein in a loading-unloading configuration the loading-unloading sub-frame is connected to the transport vehicle, and wherein in a transport configuration the loading-unloading sub-frame is disconnected from the transport vehicle.

3. The frame of claim 2 wherein the loading-unloading sub-frame is collapsible to enable storage of the loading-unloading sub-frame in the transport vehicle when disconnected from the transport vehicle.

4. The frame of claim 1 or 2 wherein the platform support means are removably connected to the transport vehicle.

5. The frame of claim 1 wherein the transport vehicle is a truck comprising a bed portion.

6. The frame of claim 5 wherein the track support means are connected to the transport vehicle by means of a connection member in the bed portion.

7. The frame of claim 5 wherein the track support means are connected to the transport vehicle by means of a fifth wheel assembly in the bed portion.

8. The frame of claim 1 wherein the track support means are connected to the transport vehicle by means of a hitch assembly.

9. The frame of claim 1 further comprising a winch assembly to enable loading and unloading of the auxiliary vehicle.

10. The frame of claim 9 wherein the winch assembly comprises a hand-operated winch.

11. The frame of claim 9 wherein the winch assembly comprises a motorized winch.

12. The frame of claim 9 wherein the loading-unloading sub-frame comprises a guide roller for guiding a cable of the winch assembly.

13. The frame of claim 1 wherein the platform support means comprise foot pegs for enabling a user to climb up to the auxiliary vehicle when positioned above the user cab of the transport vehicle.

14. The frame of claim 1 wherein the transport sub-frame comprises generally parallel tracks and guide rollers thereon for receiving and guiding the auxiliary vehicle into position on the retention platform.

15. The frame of claim 1 wherein the loading-unloading sub-frame comprises generally parallel tracks and guide rollers thereon for receiving and directing the auxiliary vehicle toward the retention platform.

16. The frame of claim 1 wherein the auxiliary vehicle is an all-terrain vehicle.

17. The frame of claim 1 wherein the auxiliary vehicle is a personal watercraft.

18. The frame of claim 1 wherein the platform support means and the track support means are each removably connected to the transport vehicle by means of quick-disconnect pin connections.

19. A frame for mounting on a transport vehicle having a user cab, for enabling loading, transportation and unloading of an auxiliary vehicle on the transport vehicle, the frame comprising:
a transport sub-frame comprising:
a retention platform for receiving the auxiliary vehicle; and
platform support means connected to the transport vehicle and the retention platform, for supporting the retention platform at a position above the user cab of the transport vehicle; and
a loading-unloading sub-frame comprising:
track means for enabling the auxiliary vehicle to access the retention platform; and
track support means connected to the transport sub-frame and the track means, for supporting the track means on the transport vehicle.

20. A frame for mounting on a transport vehicle having a user cab, for enabling loading, transportation and unloading of an auxiliary vehicle on the transport vehicle, the frame comprising:
a transport sub-frame comprising:
a retention platform for receiving the auxiliary vehicle; and
platform support means connected to the transport vehicle and the retention platform, for supporting the retention platform at a position above the user cab of the transport vehicle; and
a loading-unloading sub-frame comprising track means for enabling the auxiliary vehicle to access the retention platform, the track means connected to the transport sub-frame.
